(19) United States
(12) Patent Application Publication
(10) Pub. No.: US 2014/0040780 A1
(43) Pub. Date: Feb. 6, 2014

(54) SYSTEM AND METHOD FOR PROVIDING COLLABORATION INFORMATION AROUND PROJECTS AND ACTIVITIES USING REMOTE TIME TRIGGERS

(71) Applicant: Punch Technologies, Inc., Matthews, NC (US)

(72) Inventors: Gregory Brian Artzt, Matthews, NC (US); Carole Kuhn Tobias, Lewisville, NC (US); Charles Andrew Prisk, Clemmons, NC (US)

(73) Assignee: Punch Technologies, Inc., Matthews, NC (US)

(21) Appl. No.: 13/959,955

(22) Filed: Aug. 6, 2013

Related U.S. Application Data
(60) Provisional application No. 61/679,835, filed on Aug. 6, 2012.

(51) Int. Cl. H04L 29/06

(52) U.S. Cl. CPC H04L 65/403
USPC 715/753

(57) ABSTRACT

Providing collaboration information between a primary user and a collaborative user on a collaborative activity associated with the primary user and the collaborative user. A user computer receives a start trigger event that starts a collaborative activity session, sends a notification of the start of the collaborative activity session to a collaborative user and after receiving an end trigger event that ends the collaborative activity session, sends a notification of the ending of the collaborative activity session to the collaborative user. The method includes providing collaborative data to the collaborative users, and storing time and location information of the collaborative users. The method further includes for the prompting or automation of start or stop triggers for an activity based on other factors including the time and location of an individual moving in or out of a defined or geo-fenced region.

### TECHNICAL FIELD

The present invention relates to a computing system and a method performed by the computing system for automatically notifying and giving information to collaborative users.

### BACKGROUND OF THE INVENTION

In recent years companies and teams are more distributed and mobile than ever. Teleworking is becoming increasingly common in both companies and government agencies. Additionally, projects and other work activities are outsourced to different groups and companies across disparate locations. Managing teams and communicating across projects, work efforts, and locations has become increasingly difficult. Companies and individuals lack a structured platform that tells them in real-time (1) who amongst their connections is working, (2) what are they working on, and (3) where are they working. Without this real-time information people get interrupted, they multitask, and they lose the ability to focus on any effort until completion. Without this information, efficient collaboration and decision-making is not possible.

In addition, capturing time spent on multiple projects for multiple people located at multiple locations, either for purposes of billing, capitalization, or a simple understanding of efficiency, is so difficult with existing project management products and other business systems that it is often neglected. Or worse, workers fill out time sheets post-hoc with little in the way of accountability towards how that time is actually spent (for example, service professional such as lawyers and accountants billing hours at the end of the month).

### SUMMARY OF THE INVENTION

The present invention is a system and a method for providing collaboration information, timekeeping, and work activity tracking. The system includes a plurality of user computers, each operated by a user as described herein, as well as a collaboration server computer that serves to control communications amongst the users, and to collect various data about the collaborations that occur amongst the users. The user computers that are utilized with this invention each include a user interface, a network connection, and a processing unit. The user computer, which may be a mobile computing device, may further include a timer, a database, a GPS receiver, and a phone. The user interface is for identifying a primary user, a collaborative user, and a collaborative activity associated with the primary user and at least one collaborative user. The network connection sends communications to and receives communications from at least one collaborative user, typically via the collaboration server computer.

The processing unit of the user computer is specifically programmed to perform the method of the present invention. This method includes the steps of receiving an input identifying a primary user, a collaborative user, and a collaborative activity associated with the primary user and at least one collaborative user; sending to at least one collaborative user via the collaboration server computer an invitation to participate in the collaborative activity; and receiving from at least one collaborative user a response to the invitation. If the response comprises an acceptance, then after receiving a start trigger event that starts a collaborative activity session, the user computer sends a notification of the start of the collaborative activity session to the at least one collaborative user via the collaboration server computer, and after receiving an end trigger event that ends the collaborative activity session, the user computer sends a notification of the ending of the collaborative activity session to the at least one collaborative user via the collaboration server computer.

The method may further include the steps of the user computer initiating a primary user timer after receiving the start trigger event, stopping the primary user timer after receiving the end trigger event, reading a primary user time indication of the time between receiving the start trigger event and receiving the end trigger event and storing the primary user time indication. The method may further include the user computer initiating a collaborative user timer after receiving from the at least one collaborative user a collaborative user start trigger event, stopping the collaborative user timer after receiving from the at least one collaborative user a collaborative user end trigger event, reading a collaborative user time indication of the time between receiving the collaborative user start trigger event and receiving the collaborative user end trigger event, and storing the collaborative user time indication. The method may further include the steps of the user computer determining a primary user location associated with the primary user and storing the primary user location. The method may further include the steps of receiving a collaborative user location associated with the collaborative user. The user computer may send to the at least one collaborative user a collaborative location alert via the collaboration server computer when the primary user location is within a selected distance of the collaborator user location. Collaborative information may be in the form of messaging, notes, images, voice recordings, videos, files, phone calls, conference calls, or other forms of collaboration. The method may further include for collaborative information to be accessible during and after the collaborative activity session.

In the preferred embodiment, the user computer may receive from the at least one collaborative user, collaborative data via the collaboration server computer or the user computer may send to the at least one collaborative user collaborative data via the collaboration server computer. In one embodiment, the user computer may send collaborative data to a sales metrics computer via the collaboration server computer.

In one embodiment, the start trigger event is the primary user location determined to be a work location and the end trigger event is the primary user location determined to be not the work location after receiving the start trigger event. In another embodiment, the start trigger event is the primary user selection of an input control on the user computer and the end trigger event is the primary user selection of the input control on the user computer after receiving the start trigger event. In another embodiment, the start trigger event is a calendar entry start time for the collaborative activity session and the end trigger event is a calendar entry stop time for the collaborative activity session. In another embodiment, the start trigger event is the user computer accessing a data file and the end trigger event is the user computer closing the data file after receiving the start trigger event. In another variant, the user computer may include a phone (or a connection to a phone or it may be a mobile phone) and the start trigger event is the primary user answering a call received by the phone from collaborative user and the end trigger event is the primary user completing the call received by the phone from collaborative user.

### BRIEF DESCRIPTION OF THE DRAWING

FIG. 1 is a block diagram illustrating the system of the preferred embodiment of the present invention.

FIG. 2 is a flow diagram illustrating the methodology of preferred embodiment of the present invention.

FIG. 3 is a screenshot of a user interface on a user computer that allows a user to view or create a collaborative activity.

FIG. 4 is a screenshot of a user interface on a user computer that allows a user to initiate or change the settings of a collaborative activity, including inviting others to participate in the activity.

FIG. 5 is a screenshot of a user interface on a user computer that allows a user to see the shared information and participants including their locations for a collaborative activity.

FIG. 6 is a screenshot of a user interface on a user computer that allows a user to see snapshots and triggers of collaborative activities of multiple users across multiple collaborative activities.

FIG. 7 is a screenshot of a user interface on a user computer that allows a user to see notes for a collaborative activity.

FIG. 8 is a screenshot of a user interface on a user computer that allows a user to chat with other collaborative users.

FIG. 9 is a screenshot of a user interface on a user computer that allows a user to trigger a start or end to a collaborative activity session, including the ability to accept or reject invitations to new collaborative activities.

FIG. 10 is a screenshot of a user interface on a user computer that allows a user to see geographic information of collaborative users, including a visual status of whether they are actively engaged in a collaborative activity.

FIG. 11 is a screenshot of a user interface on a user computer that allows a user to see project activities.

FIG. 12 is a screenshot of a user interface on a user computer that allows a user to see a listing of collaborative users.

FIG. 13 is a screenshot of a user interface on a user computer that allows a user to see a running time of a collaborative activity session.

FIG. 14 is a screenshot of a user interface on a user computer that allows a user to see stored content of a collaborative activity.

FIG. 15 is a block diagram of a back-end administrative component of the preferred embodiment of the present invention.

### DETAILED DESCRIPTION

Before the present invention is described, it is to be understood that this disclosure is not limited to the particular embodiments described, as these may vary. It is also to be understood that the terminology used in the description is for purposes of describing the particular versions or embodiments only, and is not intended to limit the scope. It is to be understood that each specific element includes all technical equivalents that operate in a similar manner. In addition, a detailed description of known functions and configurations will be omitted when it may obscure the subject matter of the present invention.

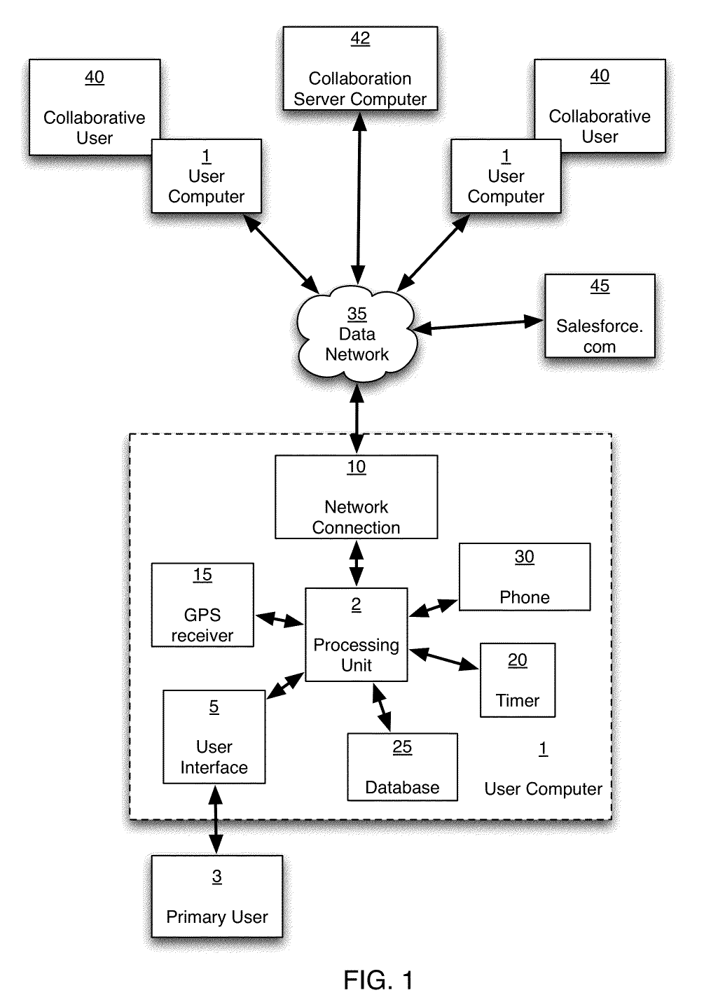

Referring to FIG. 1, the preferred embodiment system includes a user computer 1 operated by a primary user 3. The user computer 1 includes a user interface 5, a network connection 10, and a processing unit 2. In the preferred embodiment, the user computer 1 includes a phone 30, a GPS receiver 15, a timer 20, and a database 25. The user computer 1 for example may be, but is not limited to, a desktop computer, laptop, tablet, smart-phone such as an IPHONE or ANDROID device, or any other computing device with a network connection 10 to a data network 35. The user computer 1 can also access location information using other built-in technologies such as Wi-Fi or Bluetooth.

The collaborative user 40 is a person who also operates a user computer 1 as shown in FIG. 1, which may be the same as or different from the user computer 1 operated by the primary user 3. For example, the primary user 3 may use an IPHONE as a user device 1 while the collaborative user 40 uses a tablet or a desktop computer as his or her user computer 1. The most commonly used user computer 1 may be mobile in nature with the ability to capture its location using a GPS receiver 15 within the user computer 1 (or other accessible technologies). The user interface 5 allows the primary user 3 to identify himself/herself, a collaborative user 40, and a collaborative activity associated with the primary user 3 and at least one collaborative user 40. The primary user 3 may identify himself/herself at an earlier time, such as during the set up of the user computer 1. The primary user 3 identity may be an email address or another identifier.

Typically, the network connection 10 sends communications to at least one collaborative user 40 via a collaboration server computer 42 connected to the data network 35, as known by one skilled in the art. The network connection 10 also receives communications from the at least one collaborative user 40 via the collaboration server computer 42 connected to the data network 35. Use of a collaboration server computer 42 enables uniform operation of the system by distributing the required communications amongst the user computers 1, as well as data collection, collation and analysis as may be desired. However, in alternative embodiments the use of the collaboration server 42 may be reduced or even eliminated if desired. For example, communications between user computers 1 may take place over other means such as standard email or text messaging protocols, where other server computers operating on the data network 35 as well known in the art may substitute for the functionality otherwise provided by the collaboration server computer 42.

The data network 35 may be any data network, such as the Internet, that allows the user computer 1 operated by the primary user 3 to communicate with a user computer 1 operated by the collaborative users 40. In addition, the data network 35 allows the user computer 1 to access information from other third party server computers, for example, to obtain CRM information from the SALESFORCE.COM computer 45. The processing unit 2 interfaces with the network connection 10 and the user interface 5 to initiate a collaborative activity as described below.

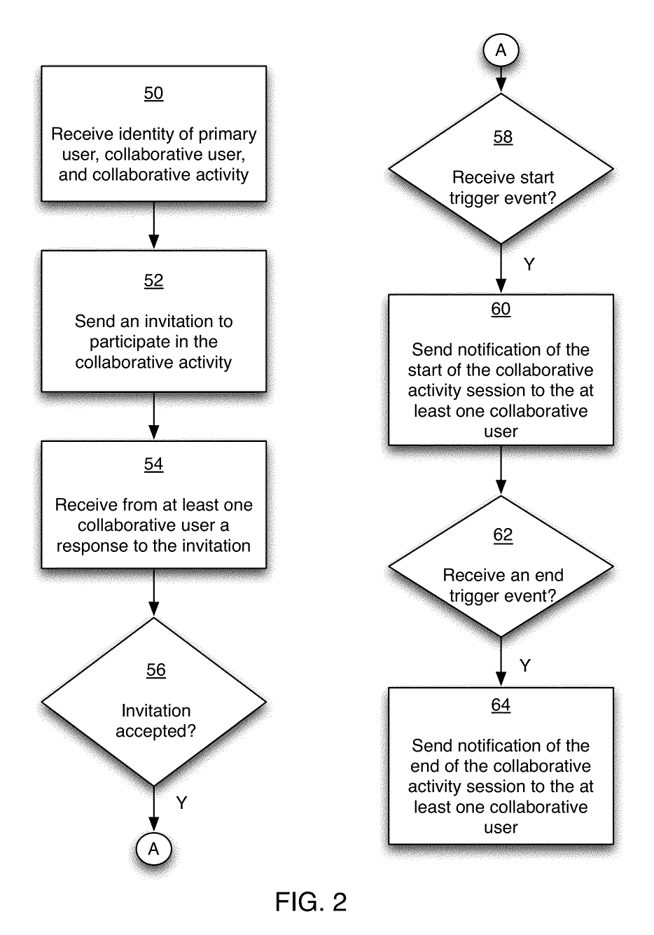

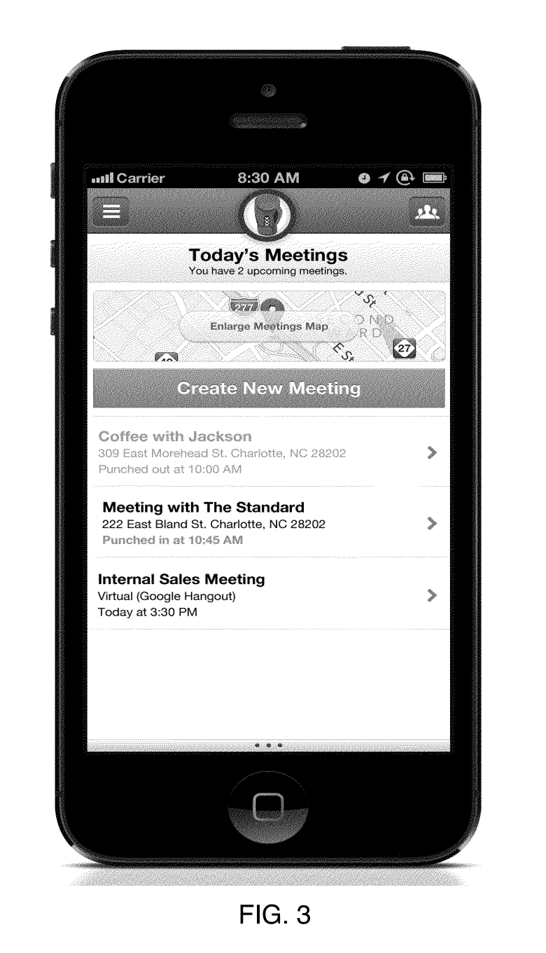

Referring to FIG. 2, the processing unit 2 is programmed to perform the following steps. First, the processing unit 2 will receive an input identifying the primary user 3, a collaborative user 40, and a collaborative activity associated with the primary user 3 and at least one collaborative user 40 (step 50). Referring to FIG. 3, the primary user 3 creates a collaborative activity by selecting an existing meeting or project from a calendar entry or other list of available collaborative activities, or the primary user 3 may create a new activity as shown. FIG. 3 illustrates an option to create a new meeting, or to select a meeting for which the user has already punched into or out of or that is planned to occur in the future. The term punch in is used generally herein to denote the start trigger or joining of a collaborative activity, and the term punch out is used to denote the end trigger or leaving a collaborative activity. In this example, the primary user has selected Meeting with the Standard as the collaborative activity from the screen of FIG. 3, which is currently in the punched in state for that user.

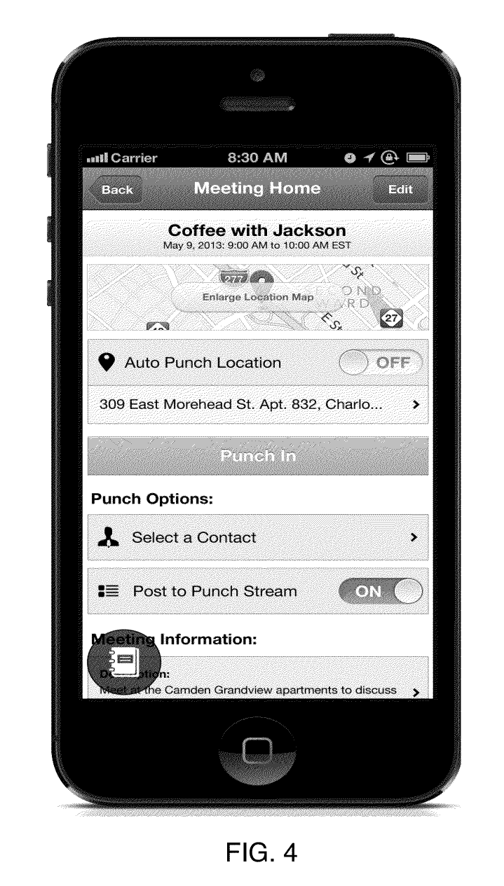

Next, the primary user 3 sends to at least one collaborative user 40 via the collaboration server computer 42 an invitation to participate in the collaborative activity (step 52). To do this the primary user selects one or more contacts (collaborative users 40) and the collaborative activity as shown in FIG. 4. An invitation sent through the system may be in the form of an email, a text message, or any other similar notification, which may be delivered via the collaboration server computer or through other known communications means.

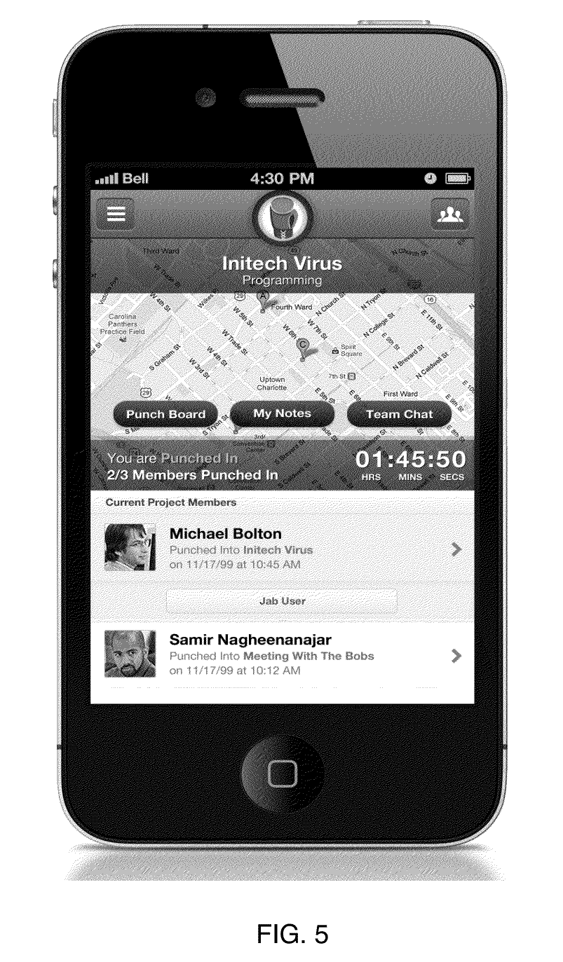

Next, the primary user 3 waits to receive a response from at least one collaborative user 40 to whom he has sent an invitation (step 54). If the response includes an acceptance (step 56), then after receiving a start trigger event the collaboration activity begins (step 58). Next, the user computer sends a notification of the start of the collaborative activity session to at least one collaborative user 40 via the collaborations server computer (step 60), as shown in FIG. 5. The notification of the start of the collaborative activity may also be in the form of an email, a text message, or any other similar notification.

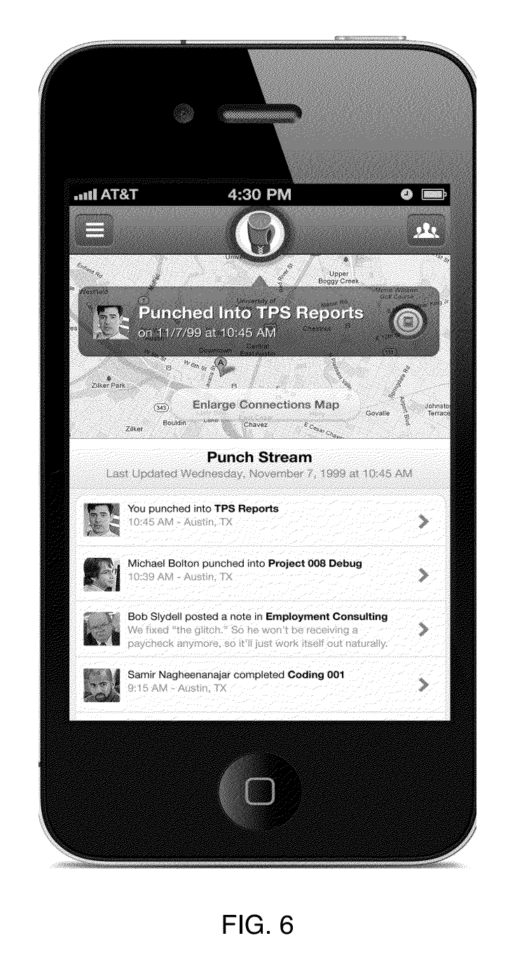

Referring to FIG. 6, when there are multiple collaborative users 40, a notification of the start of the collaborative activity session is sent to all other collaborative users 40, and information is updated regarding the status of the collaborative user 40 who activated the start trigger for that activity. After receiving an end trigger event that ends the collaborative activity session for the collaborative user 40 who provided the end trigger event, a notification is delivered to all collaborative users 40 indicating that the collaborative activity session has ended for the collaborative user 40 who provided the end trigger event. Every collaborative user 40 in the collaborative activity receives new session information from each collaborative user 40 in the collaborative activity. Although real-time collaboration sessions may include only subsets of collaborative users 40 that activated their start triggers, all collaboration information may be made available later to all collaborative users 40. Not only do collaborative users 40 receive notifications, but they may also be able to see that the person who started the event trigger is still working on that collaborative activity, until that same person who started the event trigger ends the event trigger for their involvement in that activity. Therefore, starting the event trigger for an activity does not start the trigger for other collaborative users 40 in the event. The same holds true for the end trigger. However, each trigger does update status and send notifications to all collaborative users 40 in the collaborative activity.

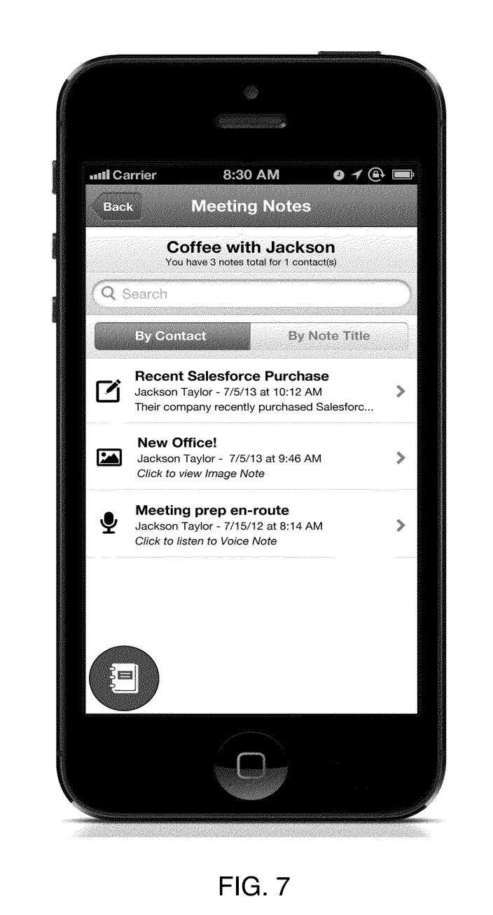

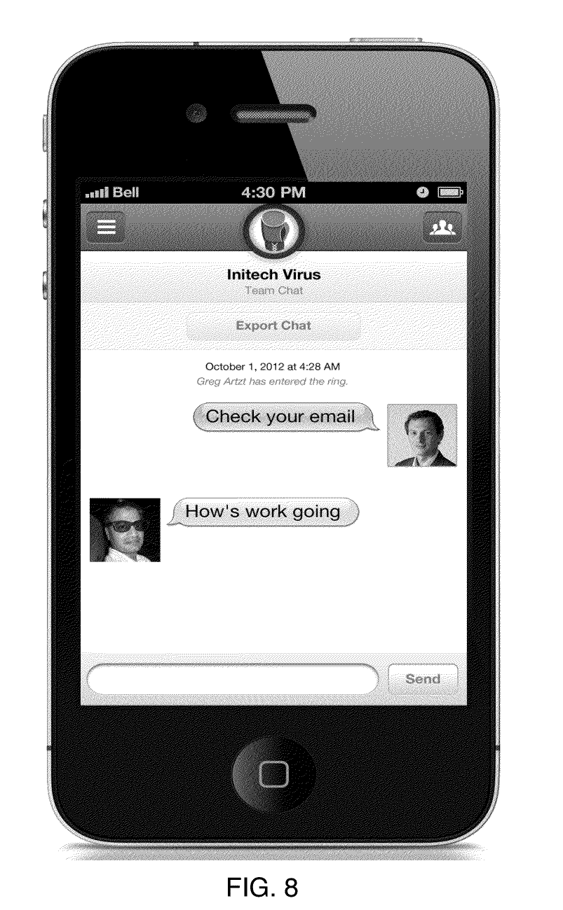

Once the collaborative activity has started, the primary user 3 and the collaborative users 40 interact in a collaborative manner on an activity or project. As shown in FIG. 7, a primary user 3 may take multiple notes for a single collaborative activity. A primary user 3 may also be punched in (collaborating) on a number of different collaborative activities. Collaborative activities or projects can be anything that an individual does during the course of a workday. Examples of activities could include phone calls, meetings, reading news, administrative work, on a call, on a lunch break, or a more standard project like fixing a broken desk or developing new code for XYZ application. Anything that a person is actively doing or working on could be considered a collaborative activity. A primary user 1 might want to create such an activity if the user either wants to capture time for the activity or wants to invite others to collaborate with the activity. In the preferred embodiment, the user computer may receive from at least one collaborative user 40, collaborative data via the collaboration server computer, or the user computer may send to the at least one collaborative user 40 collaborative data via the collaboration server computer. As shown in FIG. 7 and FIG. 8, chat, notes, stats, punchboard, and other informational or collaboration tools become available within an activity once the event trigger has started (the end event trigger reverses the course of the start event trigger).

Once the primary user 3 (or a collaborative user 40) has finished the collaborative activity, either in its completion or just for that one session, an end trigger event is received by the user computer 1 ending the collaborative activity session (step 62). The user computer 1 then sends a notification of the ending of the collaborative activity session to at least one collaborative user 40 via the collaboration server computer (step 64).

Invited collaborative users 40 may either accept or reject the invitation to the activity (e.g. project, etc.). Responses are delivered to the primary user that invited the other collaborative users 40. It should be noted that the individual or computing device 1 that created the project or activity may not be the same individual or computing device that invited the other collaborators 40 into the activity. A subset of roles may exist within a collaborative project or activity including, but is not limited to, an administrator, project manager, or member. It should also be noted that the primary user 3 associated with the collaborative activity may be associated with any number of other activities as well, which may or may not have the same collaborative users 40.

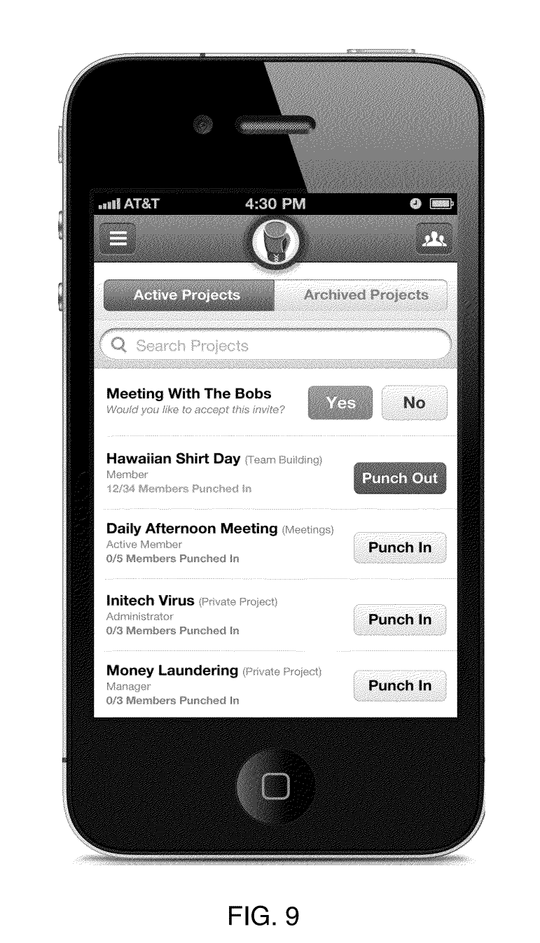

The start trigger or the end trigger for any collaborative activity can be a manual input received from the primary user 3 into the user interface 5 or an automatic trigger based on a number of actions by the primary user 3. As shown in FIG. 9, the manually triggered start/end may be the touch of an icon, i.e. the punch in and punch out buttons, on a user interface 5 screen. The manually triggered start/end may be in response to a prompt by the processing unit 2 displayed on the user interface 5 to the user 3.

In addition to a manual trigger, there may be a variety of automatic triggers that help collaborative users 40 communicate more often and more effectively. For example, the start trigger event may be a calendar entry start time for a collaborative activity session and the end trigger event may be a calendar entry stop time for the collaborative activity session. In another embodiment, the start trigger event is the user computer accessing a data file and the end trigger event is the user computer 1 closing the data file after receiving the start trigger event. In another variant, the user computer 1 may include a phone 30 (or a connection to a phone or it may be a mobile phone) and the start trigger event is the primary user answering a call received by the phone 30 from collaborative user 40 and the end trigger event is the primary user 3 completing the call received by the phone 30 from collaborative user 40.

In addition, the triggers can be automated based on geography. When working on a project, others may want to know where you are performing the work activity. This information can be provided by a device that has GPS 15, and likely other technologies that determine the location of the user 3. In this embodiment, the user computer 1 determines a primary user location associated with the primary user 3 and stores the primary user location. If a geographic polygon or fence (geo-fence) was defined as a place of work, a user 3 may automatically activate the trigger when they enter that geographic space, as identified by the location service of the mobile device 1. In this embodiment, the start trigger event may be the user's location determined to be a work location and the end trigger event is the user's location determined to be not the work location after receiving the start trigger event.

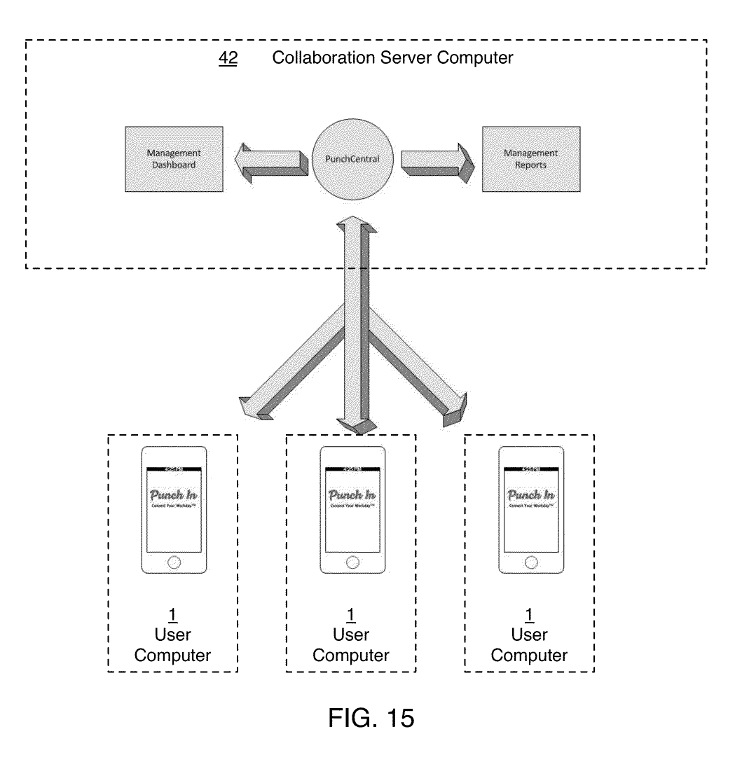

Work locations as described above for automated start and stop triggers can be created in three different ways. First, work locations for automated triggering can be created by an individual from the user computer 1, which is often mobile on a map interface. This automated work location can then also be distributed to other collaborative users 40. Second, work locations for automated triggering can be set by an administrator from the server computer 42, and distributed to any set of collaborative users 40 on their user computers 1. In this case, referring to FIG. 15, we refer to the system running on the server computer 42 as PunchCentral. Third, work locations for automated triggering can be pulled from other integrated business systems. For example, referring back to FIG. 1, a customer location for a service order or meeting could be pulled from a CRM computer such as the SALESFORCE.COM computer 45.

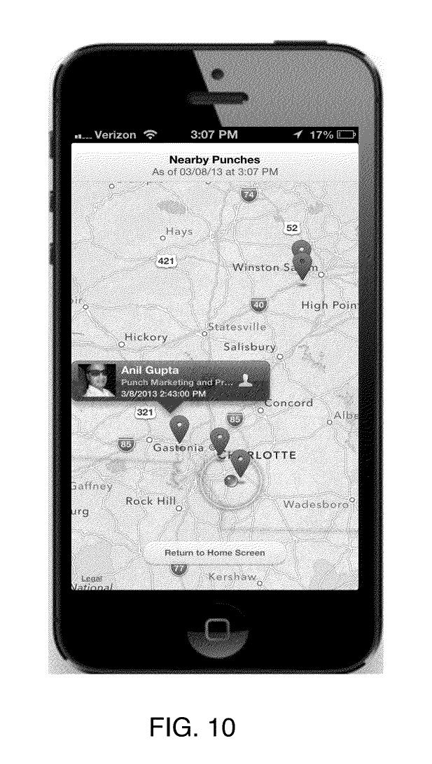

Referring to FIG. 10, geographic based automated activation can occur based on discovery with other nearby devices 1 (using technologies such as Bluetooth, for example). In this embodiment, the user computer 1 receives a collaborative user location associated with the collaborative user 40. The user computer 1 may send to the at least one collaborative user 40 a collaborative location alert via the collaboration server computer when the primary user location is within a selected distance of the collaborator user location.

Upon activation of a start or end event for an activity, the GPS 15 of the mobile phone 1 can be utilized, along with questions to the user 3, to identify the exact location of the user 3. Another example of a way to automate the triggers using such hardware is by the device identifying movement of a certain speed or direction. Other location technology in the user computer 1 could be used as well to identify and share one's location in the occurrence of a start or stop trigger for an activity.

In addition to attaching location to event triggers, users 3 may wish to attach location to any collaborative action such as chat, notes, or other. In the workplace, an employer may wish to only allow an event trigger (in or out) based on whether or not the user 3 is in a specific location (e.g. in the office). This may be used to authenticate a paid work session. An employer may similarly want to authenticate a paid work session using time of day limits, day of week limits, or collaborative group limits. Conversely an employer may pay a premium rate for work sessions at specific location, times, or with specific collaborative groups.

Additional automated event triggers may be a set of rules and integrations, which can allow an event trigger to automatically start or cease. These include, but are not limited to:

1. Mobile phone activity monitoring—For example, if every time you take a phone call it automatically triggers the activity labeled phone call to be started.
2. Time based—An event trigger can be automatically started or prompted to ask the user to start at a pre-set time, or in a pre-set amount of time such as with a timer.
3. Location based—An event trigger can be automatically started or prompted to ask the user to start based on showing up or leaving a given location. This would be achieved via GPS, Bluetooth, or some other location tracking technology embedded in the device 1 running the method.
4. Computer application monitoring—An event trigger can be automatically started or prompted to ask the user 3 to start based on usage of a hardware or software application (including websites, mobile applications, and more) that can be monitored, and tied to a collaboration activity. For example, monitoring Microsoft Outlook for email use could prompt the activation of a start event for an “email” collaboration activity.
5. External API integration feeding automation—Other applications could feed an API informing the device 1 to automatically punch in based on pre-defined rules.
6. The event trigger could be automated by rules dependent upon the combination of any of the above sources (e.g. Location & Time)

Furthermore, each collaborative user 40 may have their own unique start and end trigger events for each collaborative activity. In addition, it is possible to activate an end trigger for one activity automatically simply by activating a start trigger for a different activity.

Once other collaborative users 40 realize that another individual in the activity has started their event trigger for the activity (and is working on that activity), then they may choose to do the same while multiple individuals on the team are available. This decision results in work being accomplished by more complete teams at more appropriate times, rather than the traditional way of disparate teams working on the same project at different times. The other collaborative users 40 can then start their event trigger for their activity. Once multiple individuals and devices have started the activity event triggers in the activity, collaboration and functionality opens up for the activity (or project). Some activities may be public in nature (anyone can find and see working status around the activities, though not actually participating), and others may be private (only visible to the invited project members)

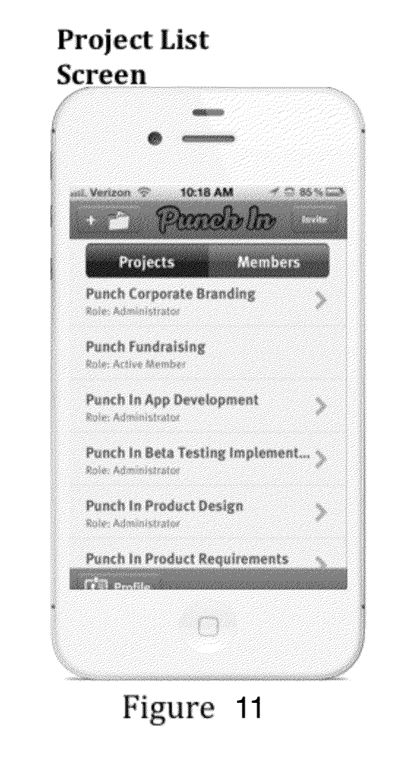

Referring to FIG. 11, this is the main project list page where all activities for the user 3 are listed. All projects/activities are listed regardless of the role the individual plays in that activity. (e.g. primary user 3, collaborative user 40, etc.). From this page, users can: create a project/activity (top left button); invite collaborators; receive (Event Trigger) Punch In/Out notifications; join a project/activity; and view all connected projects/activities

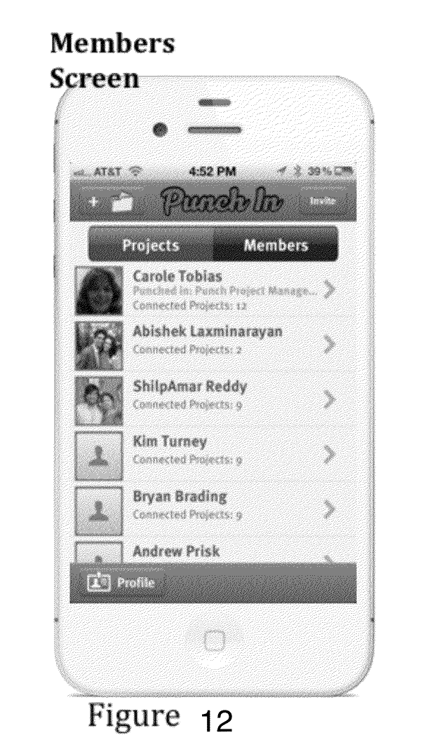

Referring to FIG. 12, this is the member (i.e. user) list page where a user 3 can navigate through all their other collaborative users 40 on common collaborative activities. Users can: View all connected members (users); monitor member (user) punch status; communicate with member (user) through Chat; and view member (user) project connections.

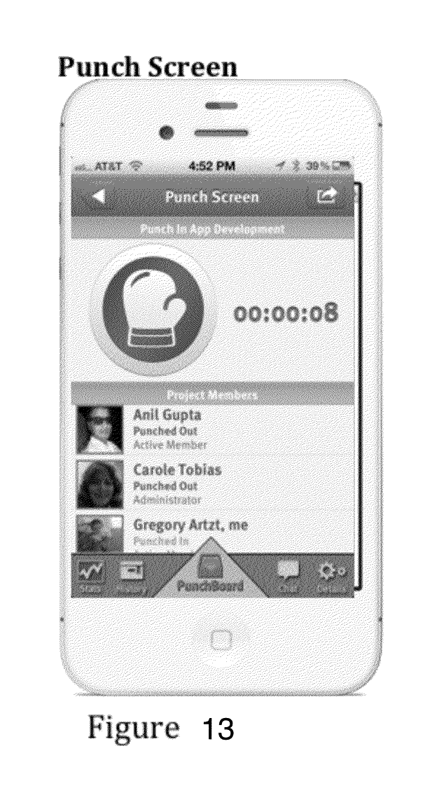

Referring to FIG. 13, this is the Punch Screen, which is the main page for any project or activity. It is from here that all manual event triggers are started and finished. Additional functionality may be opened up upon initiating the start trigger depending on the use-case. This functionality may include but is not limited to: capture of time and locations; editing punches (in and out); communicating with project members; entering into a group Chat; having access to a PunchBoard (including notes, lists, files, images, recordings, videos, etc.); creating and edit project notes; tracking history; and tracking location and monitoring project stats including time logs.

Time capture is an important by-product of the present invention of collaborating around projects and creating real-time awareness in the work place. As part of this method, the time component could be integrated with billing systems to automatically bill out time captured for activities in between the start and end triggers. Examples of such billing systems include QUICKBOOKS and FRESHBOOKS.

As shown in FIG. 13, the user interface 5 for a triggered activity session, the “PunchScreen,” may include a running timer. The primary user time capture embodiment includes the steps of the user computer 1 initiating a primary user timer 20 after receiving the start trigger event, Punch in selection by the user 3; stopping the primary user timer 20 after receiving the end trigger event; reading a primary user time indication of the time between receiving the start trigger event and receiving the end trigger event and storing the primary user time indication in database 25.

Time can also be captured for all collaborative users 40 for all collaborative activities by measuring between the time they start their event trigger and the time they end the event trigger. The collaborative user time capture embodiment includes the user computer 1 initiating a collaborative user timer (which is a separate timer not shown) after receiving from at least one collaborative user 40 a collaborative user 40 start trigger event, stopping the collaborative user timer after receiving from the at least one collaborative user a collaborative user 40 end trigger event, reading a collaborative user time indication of the time between receiving the collaborative user start trigger event and receiving the collaborative user end trigger event, and storing the collaborative user time indication.

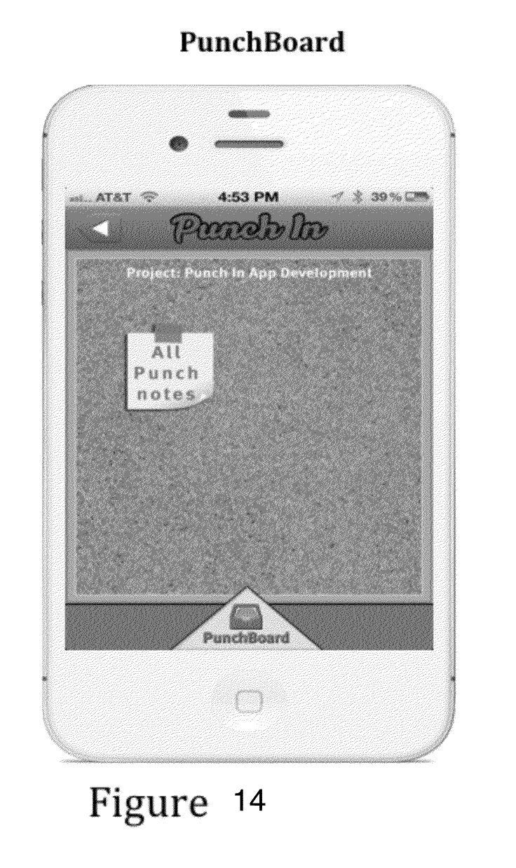

Shown in FIG. 14 is the Punchboard. This is one user interface 5 implementation for which content may be stored around a collaborative activity. This includes shared notes, files, videos, audio clips, post-its, or other ways of sharing or storing content.

The method and system of the present invention become extremely important to organizations once there is an administrative control and set of reporting wrapped around the method. This basic back-end administrative component is visualized in FIG. 15, which in the preferred embodiment would be implemented by the collaboration server computer.

Although the preferred embodiments of the invention have been described above by way of example only, it will be understood by those skilled in the art that modifications may be made to the disclosed embodiments without departing from the scope of the invention. For example, a pair of glasses could be Bluetooth enabled and used to automatically create start or stop triggers. Or any other device with Internet access such as a watch, belt, headpiece, or even clothing could be used to track movement and prompt a start or stop trigger. The invention still applies to triggers that don't always capture time, capture location, or prompt collaboration. It applies to use of such triggers by an individual, or a collaborating team.

What is claimed is:

1. A method for providing collaboration information, comprising:
a user computer receiving an input identifying a primary user, a collaborative user, and a collaborative activity associated with the primary user and at least one collaborative user;
the user computer sending to the at least one collaborative user via a collaboration server computer an invitation to participate in the collaborative activity;
the user computer receiving from the at least one collaborative user via the collaboration server computer a response to the invitation;
if the response comprises an acceptance, then:
after receiving a start trigger event that starts a collaborative activity session, the user computer sending a notification of the start of the collaborative activity session to the at least one collaborative user via the collaboration server computer; and
after receiving an end trigger event that ends the collaborative activity session, the user computer sending a notification of the ending of the collaborative activity session to the at least one collaborative user via the collaboration server computer.

2. The method of claim 1, further comprising:
the user computer initiating a primary user timer after receiving the start trigger event;
the user computer stopping the primary user timer after receiving the end trigger event;
the user computer reading a primary user time indication of the time between receiving the start trigger event and receiving the end trigger event; and
the user computer storing the primary user time indication.

3. The method of claim 2, further comprising the steps of:
the user computer initiating a collaborative user timer after receiving from the at least one collaborative user a collaborative user start trigger event;
the user computer stopping the collaborative user timer after receiving from the at least one collaborative user a collaborative user end trigger event;
the user computer reading a collaborative user time indication of the time between receiving the collaborative user start trigger event and receiving the collaborative user end trigger event; and
the user computer storing the collaborative user time indication.

4. The method of claim 1, further comprising the user computer determining a primary user location associated with the primary user and storing the primary user location.

5. The method of claim 4, further comprising the user computer receiving a collaborative user location associated with at least one collaborative user.

6. The method of claim 4, wherein the start trigger event is the primary user location determined to be a work location and the end trigger event is the primary user location determined to be not the work location after receiving the start trigger event.

7. The method of claim 1, wherein the start trigger event is the primary user selection of an input control on the user computer and the end trigger event is the primary user selection of the input control on the user computer after receiving the start trigger event.

8. The method of claim 1, wherein the start trigger event is a calendar entry start time for the collaborative activity session and the end trigger event is a calendar entry stop time for the collaborative activity session.

9. The method of claim 1, wherein the start trigger event is the user computer accessing a data file and the end trigger event is the user computer closing the data file after receiving the start trigger event.

10. The method of claim 1, wherein the user computer comprises a phone and the start trigger event is the primary user answering a call received by the phone from a person associated with the collaborative activity and the end trigger event is the primary user completing the call received by the phone from a person associated with the collaborative activity.

11. The method of claim 1, further comprising the user computer receiving from the at least one collaborative user, collaborative data via the collaboration server computer.

12. The method of claim 1, further comprising the user computer sending to the at least one collaborative user, collaborative data via the collaboration server computer.

13. The method of claim 1, further comprising the user computer sending collaborative data to a sales metrics computer via the collaboration server computer.

14. The method of claim 5, further comprising the user computer sending to the at least one collaborative user a collaborative location alert via the collaboration server computer when the primary user location is within a selected distance of the collaborator user location.

15. The method of claim 1, wherein the user computer is a mobile computer device.

16. A user computer for providing collaboration information, comprising:
a user interface for identifying a primary user, a collaborative user, and a collaborative activity associated with the primary user and at least one collaborative user;
a network connection for:
sending communications to the at least one collaborative user via a collaboration server computer; and
receiving communications from the at least one collaborative user via the collaboration server computer; and
a processing unit programmed to:
send to the at least one collaborative user an invitation to participate in the collaborative activity via the collaboration server computer;
receive from the at least one collaborative user a response to the invitation via the collaboration server computer;
if the response comprises an acceptance, then:
after receiving a start trigger event that starts a collaborative activity session,
send a notification of the start of the collaborative activity session to the at least one collaborative user via the collaboration server computer; and
after receiving an end trigger event that ends the collaborative activity session, send a notification of the ending of the collaborative activity session to the at least one collaborative user via the collaboration server computer.

17. The user computer of claim 16, further comprising:
a timer for indicating a primary user time indication of the time between receiving the start trigger event and receiving the end trigger event; and
a database for storing the primary user time indication.

18. The user computer of claim 16, further comprising a GPS receiver for determining a primary user location associated with the primary user and wherein the start trigger event is the primary user location determined to be a work location and the end trigger event is the primary user location determined to be not the work location after receiving the start trigger event.

19. The user computer of claim 16, wherein the user computer is a mobile computer device.

20. The user computer of claim 16, wherein the user computer comprises a phone.
